(19) United States
(12) Patent Application Publication
(10) Pub. No.: US 2011/0116862 A1
(43) Pub. Date: May 19, 2011

(54) LOCK

(75) Inventors: Chih-Chen Lo, Taipei City (TW); Chih-Chin Yu, Taipei City (TW)

(73) Assignee: Inventec Corporation, Taipei City (TW)

(21) Appl. No.: 12/646,987

(22) Filed: Dec. 24, 2009

(30) Foreign Application Priority Data
Nov. 18, 2009 (TW) 98139210

(51) Int. Cl. F16B 21/07

(52) U.S. Cl. 403/326

(57) ABSTRACT

A lock includes a lock head, a fixing base and a locking component. The lock head has a first portion, a second portion and a neck portion, wherein the diameter of the neck portion is less than those of the first and the second portions. The fixing base has an opening, wherein the first and the neck portions are disposed. The locking component pivoted at an end of the fixing base includes a pivot shaft and a swing part. The pivot shaft goes through the swing part and the fixing base so that the swing part is able to rotate about the pivot shaft. The swing part has a latch portion. When the swing part is at a locking position, the latch portion is locked at an accommodating space formed by the neck, the first and the second portions so as to fix the lock head in the fixing base.

### CROSS-REFERENCE TO RELATED APPLICATION

This application claims the priority benefit of Taiwan application serial no. 98139210, filed on Nov. 18, 2009. The entirety of the above-mentioned patent application is hereby incorporated by reference herein and made a part of specification.

### BACKGROUND OF THE INVENTION

1. Field of the Invention

The present invention generally relates to a lock, and more particularly, to a lock different from the prior art.

2. Description of Related Art

A docking station used for a portable computer enables the user to connect computer peripheral equipments such as mouse, printer or network interface card (NIC) to the docking station in long term. Whenever the above-mentioned peripheral equipments are to be used, the connector of the portable computer is connected to the connector of the docking station only, so as to use the peripheral equipments. In this way, not only the light and handy feature of the portable computer can be achieved, but also the troubles of putting in for connection and putting out for disconnection can be avoided. On the other hand, in order to avoid the portable computer connecting the docking station from being thieved, usually a Kensington lock is used to lock the docking station at a fixing place and the portable computer is also locked on the docking station.

### SUMMARY OF THE INVENTION

Accordingly, the present invention is directed to a lock with a shape and a structure different from the conventional one.

The present invention provides a lock, which includes a lock head, a fixing base and a locking component. The lock head has a first portion, a second portion and a neck portion connected between the first portion and the second portion, wherein the diameter of the neck portion is less than the diameters of the first portion and the second portion. The fixing base has an opening, and the first portion and the neck portion of the lock head suit to be disposed in the opening. The locking component is pivoted at an end of the fixing base and includes a pivot shaft and a swing part. The pivot shaft herein located at a side of the swing part goes through the swing part and into the fixing base so that the swing part is able to rotate in relation to the fixing base about the pivot shaft as the rotating center. The swing part has a latch portion. When the swing part is located at a locking position, the latch portion is locked at an accommodating space formed by the neck portion, the first portion and the second portion so as to fix the lock head in the fixing base.

In an embodiment of the lock of the present invention, the above-mentioned first portion, second portion and neck portion are cylinders.

In an embodiment of the lock of the present invention, the surface of the above-mentioned first portion far away from the second portion is arc-shaped.

In an embodiment of the lock of the present invention, the above-mentioned first portion has a groove, the fixing base has a position-limiting part, and the position-limiting part suits to be locked in the groove.

In an embodiment of the lock of the present invention, the cross-section profile of the above-mentioned swing part is L-shaped.

In an embodiment of the lock of the present invention, the above-mentioned second portion connects an end of a cable.

Based on the mentioned above, the shape, the structure and the locking method of the lock of the present invention are different from the conventional Kensington lock, so that the provided lock has great patentability.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a lock according to an embodiment of the present invention.

FIG. 2 is a cross-sectional diagram showing the lock of FIG. 1 is placed in an electronic apparatus for use.

FIG. 3 is a diagram showing the lock head of the lock in FIG. 1 is not inserted into the fixing base and the swing part is in unlocked status.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

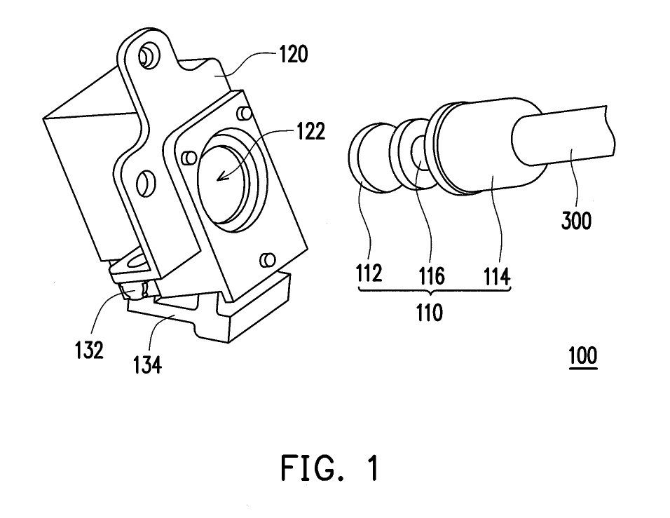

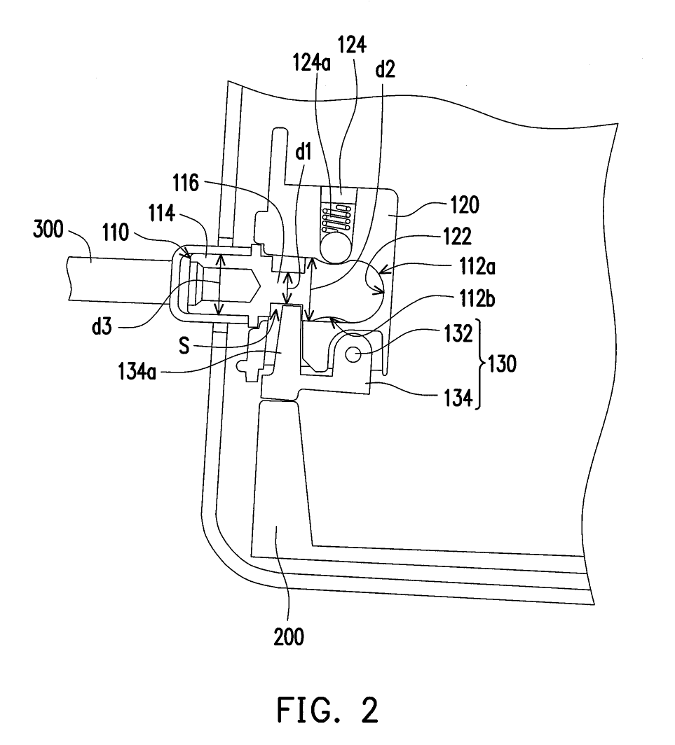

FIG. 1 is a diagram of a lock according to an embodiment of the present invention, and FIG. 2 is a cross-sectional diagram showing the lock of FIG. 1 is placed in an electronic apparatus for use. Referring to FIGS. 1 and 2, a lock 100 of the embodiment includes a lock head 110, a fixing base 120 and a locking component 130. The lock head 110 has a first portion 112, a second portion 114 and a neck portion 116 connected between the first portion 112 and the second portion 114, wherein the diameter d1 of the neck portion 116 is less than the diameter d2 of the first portion and the diameter d3 of the second portion. The fixing base 120 has an opening 122, wherein the first portion 112 and the neck portion 116 of the lock head 110 are disposed in the opening 122. The locking component 130 is pivoted at an end of the fixing base 120 and includes a pivot shaft 132 and a swing part 134, wherein the pivot shaft 132 located at a side of the swing part goes through the swing part 134 and into the fixing base 120 so that the swing part 134 can rotate in relation to the fixing base 120 about the pivot shaft 132 as a rotating center. The swing part 134 has a latch portion 134a. When the swing part 134 is located at a locking position, the latch portion 134a is wedged in an accommodating space S formed by the neck portion 116, the first portion 112 and the second portion 114 so as to fix the lock head 110 in the fixing base 120.

Continuing to FIGS. 1 and 2, in the embodiment, the shapes of the above-mentioned first portion 112, second portion 114 and neck portion 116 are cylinders, wherein the surface 112a of the first portion 112 far away from the second portion 114 is arc-shaped, and the second portion 114 connects a cable 300. In addition, the first portion 112 further has a groove 112b on a circumrotating surface thereof, the fixing base 120 further has a position-limiting part 124, a spring 124a is disposed in the position-limiting part 124 and the spring 124a enables the position-limiting part 124 to move along the profile of the surface 112a of the first portion 112 of the lock head 110 so as to make the position-limiting part 124 wedged in the groove 112b. A cross-section profile of the above-mentioned swing part 134 is L-shaped.

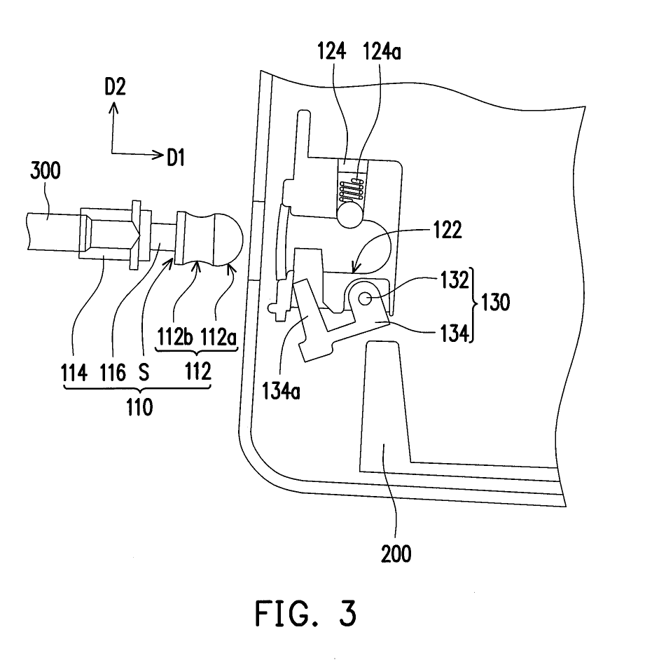

In more details, the lock 100 of the embodiment can be used in an electronic apparatus (not shown), and the electronic apparatus is, for example, a docking station of a notebook computer. FIG. 3 is a diagram showing the lock head of the lock in FIG. 1 that is not inserted into the fixing base and the swing part is in unlocked status. Referring to FIG. 3, the lock head 110 is assembled into the fixing base 120 through the opening 122 along a direction D1. The surface 112a of the first portion 112 of the lock head 110 is arc-shaped. The spring 124a of the position-limiting part 124 makes the position-limiting part 124 move along the profile of the surface 112a towards a direction D2 so that the first portion 112 of the lock head 110 can smoothly enter the opening 122, wherein the direction D2 is substantially perpendicular to the direction D1. When the lock head 110 keeps moving towards the direction D1 and enters into the fixing base 120 through the opening 122, the position-limiting part 124 moves along the profile of the first portion 112 and then is wedged in the groove 112b. At the time, by means of the wedging between the position-limiting part 124 and the groove 112b, the lock head 110 is temporarily fixed in the fixing base 120. Meanwhile, the swing part 134 swings about the pivot shaft 132 as the axis center and then hangs down. The situation that the above-mentioned lock head 110 is temporarily fixed in the fixing base 120 represents the lock head 110 is not completely fixed in the fixing base 120 yet, so that the user can take away the lock head 110 against the direction D1 from the fixing base 120.

Continuing to FIG. 2, in order to fix the lock head 110 in the fixing base 120 in long term, a linkage part 200 of the electronic apparatus (not shown) needs to move against the direction D1, and meanwhile, the linkage part 200 would make the hanging down end of the swing part 134 (i.e., the end of the swing part 134 that the latch portion 134a is disposed thereof) rotate to the locking position about the pivot shaft 132 as the axis center. At the time, the latch portion 134a of the swing part 134 is wedged in an accommodating space S formed by the neck portion 116, the first portion 112 and the second portion 114, and the lock head 110 is fixed in the fixing base 120. If the linkage part 200 keeps the position unchanged, the latch portion 134a is also wedged in the accommodating space S. Restricted by the locking component 130, the lock head 110 is unable to be drawn from the fixing base 120. The second portion 114 of the lock head 110 connects an and of a cable 300, and another end of the cable 300 can be fixed at other objects, for example, at a table, so as to prevent the electronic apparatus from being thieved. The lock 100 of the embodiment is also used to lock a notebook computer with a docking station.

In summary, the shape of the lock of the present invention is different from the shape of the conventional lock, and the locking status of the lock of the present invention is controlled by a linkage part in an electronic apparatus; i.e., whether or not the lock head is locked in the fixing base by the locking component depends on the position of the linkage part. In this way, the structure of the lock of the present invention and the technical feature to perform the locking are different from the conventional lock used in an electronic apparatus and the lock of the present invention has great patentability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lock, comprising:
a lock head, having a first portion, a second portion and a neck portion connected between the first portion and the second portion, wherein the diameter of the neck portion is less than the diameters of the first portion and the second portion;
a fixing base, having an opening, wherein the first portion and the neck portion of the lock head are disposed in the opening;
a locking component, pivoted at an end of the fixing base and comprising:
a pivot shaft; and
a swing part, wherein the pivot shaft located at a side of the swing part goes through the swing part and into the fixing base so that the swing part rotates in relation to the fixing base about the pivot shaft as a rotating center, the swing part has a latch portion and when the swing part is located at a locking position, the latch portion is locked at an accommodating space formed by the neck portion, the first portion and the second portion so as to fix the lock head in the fixing base.

2. The lock as claimed in claim 1, wherein the first portion, the second portion and the neck portion are cylinders.

3. The lock as claimed in claim 1, wherein a surface of the first portion far away from the second portion is arc-shaped.

4. The lock as claimed in claim 1, wherein the first portion has a groove, the fixing base has a position-limiting part, and the position-limiting part is locked in the groove.

5. The lock as claimed in claim 1, wherein a cross-section profile of the swing part is L-shaped.

6. The lock as claimed in claim 1, wherein the second portion connects an end of a cable.
